(19) United States
(12) Patent Application Publication
(10) Pub. No.: US 2016/0008748 A1
(43) Pub. Date: Jan. 14, 2016

(54) FILTER DEVICE FOR CONTINUOUSLY FILTERING

(71) Applicants: GKN SINTER METALS ENGINEERING GMBH, Radevormwald (DE); PURE FLUID INDUSTRIAL Inc., Beijing (CN)

(72) Inventor: Jitao Zhou, Beijing (CN)

(21) Appl. No.: 14/765,726

(22) PCT Filed: Feb. 5, 2014
(86) PCT No.: PCT/EP2014/000304

§ 371 Date: Aug. 4, 2015

(30) Foreign Application Priority Data
Feb. 5, 2013 (CN) 201310047291.5

(51) Int. Cl. B01D 29/66; B01D 29/52

(52) U.S. Cl. CPC B01D 29/66; B01D 29/52

(57) ABSTRACT

This invention relates to the filtering field, and particularly to a filter device for continuously filtering. The filter device is characterized by comprising a reverser and N filters, wherein an inlet for a material to be filtered is formed at a lower end of the side wall of the reverser; N material outlets are formed at an upper end of the side wall of the reverser; a rotor is arranged inside the reverser, and is arranged in a way of rotating around a center shaft; N openings are provided on the side wall of the rotor at positions corresponding to the material outlets of the reverser; one opening of the rotor is communicated with a slag discharge port formed in a bottom of the reverser; the N-1 openings of the rotor are limiting holes with sequentially-increased diameters, and are communicated with the inlet for the material to be filtered at the lower end of the side wall of the reverser; a filter core is mounted inside each of the N filters; and the N-1 filters are communicated with the inlet for the material to be filtered, and the other filter is communicated with the slag discharge port. The present invention reduces the number of filter cores and valves used, cuts costs and effectively controls the flow of each filter.

### FIELD OF THE INVENTION

The present invention relates to the filtering field, and particularly to a filter device for continuously filtering.

### BACKGROUND OF THE INVENTION

In order to ensure a continuous and stable outlet flow, a full-automatic filtering system required to be recycled via back-wash operation generally employs a configuration mode in which a set of filter device includes two filters. When one filter operates online, the other is recycled by means of back-wash operation. As such, the outlet flow of the whole filtering system can be ensured continuous and stable. Under normal operation, in fact only one filter performs the filtering operation. The second filter is arranged only for the reason of meeting the requirement for the continuous discharge of the material in use. Hence, there are a large number of valves and meters which match one another. If any valve and meter malfunctions, the filtering system will fail.

### SUMMARY OF THE INVENTION

In view of the above technical problem, the present invention designs and develops a filter device for continuously filtering, aiming to, on the premise of ensuring work efficiency, reduce the number of valve cores and valves used, cut costs and effectively control the flow of each filter.

The present invention provides the following technical solutions:

A filter device for continuously filtering, comprising:

a reverser being a cylindrical container, an inlet for a material to be filtered is formed at a lower end of the side wall of the reverser, N material outlets are formed at an upper end of the side wall of the reverser; a rotor is arranged inside the reverser and arranged in a way rotatable around a center shaft, N openings are provided on the side wall of the rotor at positions corresponding to the material outlets of the reverser, the opening of the rotor is connected to the material outlet of the reverser via a seal seat to form a sealed channel, one opening of the rotor is communicated with a slag discharge port formed in a bottom of the reverser, the N-1 openings of the rotor are limiting holes with sequentially-increased diameters, and are communicated with the inlet for the material to be filtered at the lower end of the side wall of the reverser;

N filters each having a filter core mounted therein, the N-1 filters being communicated with the inlet for the material to be filtered via the material outlets of the reverser and the limiting holes of the rotor, and the remaining one filter being communicated with the slag discharge port via the material outlet of the reverser and the sealed channel.

Preferably, in the filter device for continuously filtering, once the rotor rotates one time at a predetermined time interval, the filter connected to the reverser sequentially switches to a position with an increased diameter of an adjacent limiting hole and is communicated with the corresponding limiting hole. During the filtering, there is always one filter arranged in a way of communicating with the slag discharge port to perform back-wash operation, and the remaining N-1 filters maintains the same flow of material due to provision of the limiting hole.

Preferably, in the filter device for continuously filtering, one opening of the rotor is communicated with the slag discharge port provided at the bottom of the reverser via a slag discharge pipe disposed in the interior of the reverser, and the slag discharge pipe is integrally disposed with the rotor.

Preferably, in the filter device for continuously filtering, the diameter of one opening of the rotor communicated with the slag discharge port of the reverser is identical with an diameter of the material outlets of the reverser.

Preferably, in the filter device for continuously filtering, at an upper end of a central shaft of the reverser is connected with a deceleration clutch which is connected to an implement mechanism, the deceleration clutch is disposed in a way of converting a 90-degree reciprocating movement of the implement mechanism in a manner that the rotor rotating about the central shaft rotates by a position of one limiting hole each time.

Preferably, in the filter device for continuously filtering, the filter core is made of a back-washable recycled material, for example, a metal power sintered filter core or metal mesh.

In the filter device for continuously filtering according to the present invention, a plurality of filters is communicated with the inlet for the material to be filtered and the slag discharge port via the reverser, limiting holes with different diameters are provided on the rotor at the material outlets of the reverser according to duration of online operation time of each filter to ensure the same material flow of each filter. Automatic backwash is performed by switching the filter to connect with the material outlets and the slag discharge port by means of the rotation of the rotor in the reverser at an even time interval. In the present invention, a plurality of filters operates simultaneously. Due to movement of the rotor, each filter may be communicated with the slag discharge port for backwash. On the premise of ensuring the same operation efficiency, the present invention reduces the number of valve cores and valves used and cuts production costs.

### BRIEF DESCRIPTION OF DRAWINGS

FIG. 1 is a schematic view of a work flow of a filter device for continuously filtering according to the present invention;

FIG. 2 is a sectional schematic view of the filter device for continuously filtering according to the present invention;

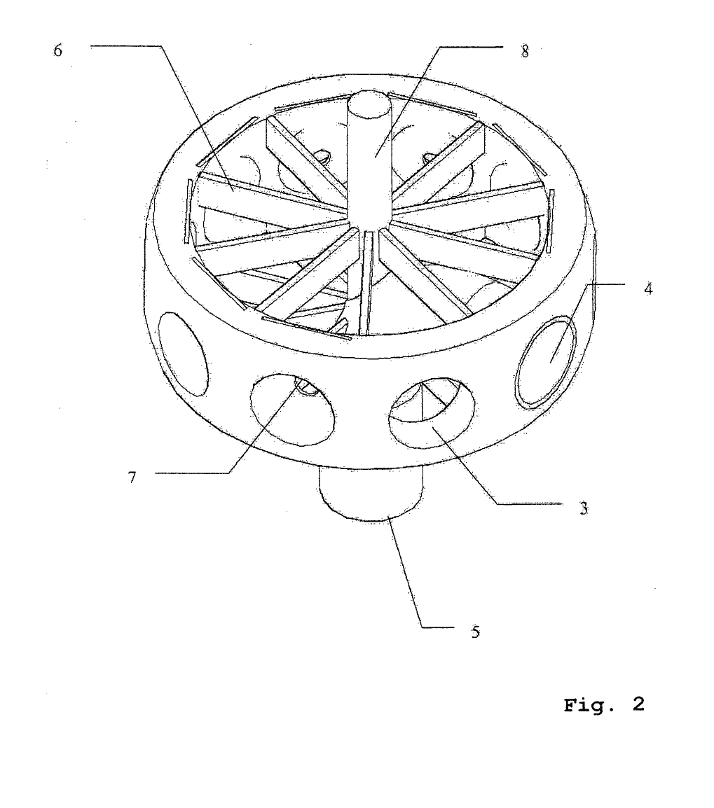

FIG. 3 is a schematic view of a rotor of the filter device for continuously filtering according to the present invention.

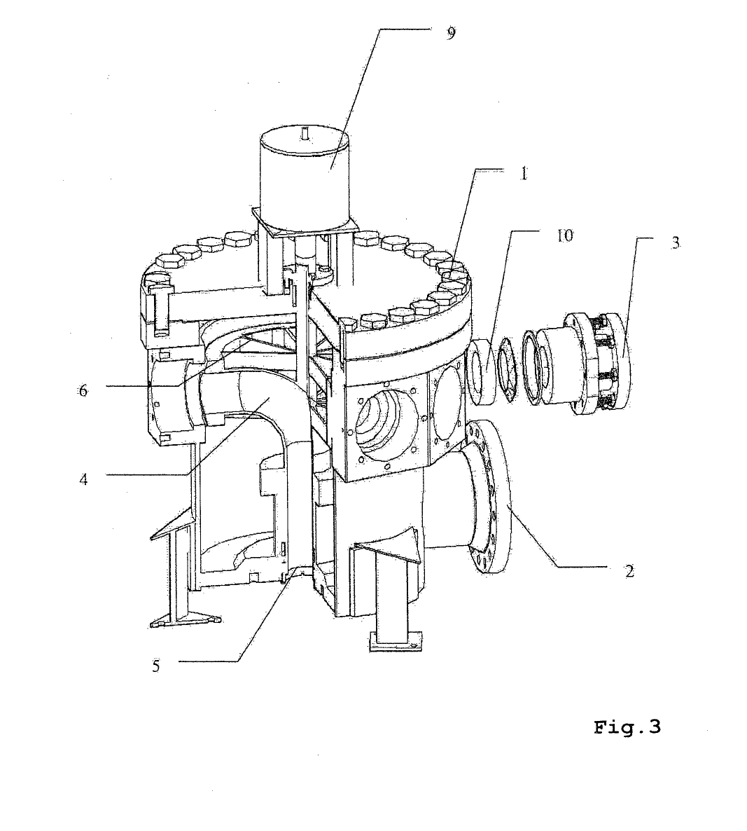

### DETAILED DESCRIPTION OF PREFERRED EMBODIMENTS

the present invention will be described in more detail with reference to the accompanied drawings to enable those skilled in the art to implement the present invention with reference to the disclosure of the description.

The present invention provides a filter device for continuously filtering, comprising:

a reverser 1 being a cylindrical container, an inlet 2 for a material to be filtered is formed at a lower end of the side wall of the reverser; N material outlets 3 are formed at an upper end of the side wall of the reverser; a rotor 6 is arranged inside the reverser, and is arranged in a way of rotating around a center shaft 8; N openings are provided on the side wall of the rotor at positions corresponding to the material outlets of the reverser; the opening of the rotor is connected to the material outlet of the reverser via a seal seat 10 to form a sealed channel, one opening of the rotor is communicated with a slag discharge port 5 formed in a bottom of the reverser, the N-1 openings of the rotor are limiting holes 7 with sequentially-increased diameters, and are communicated with the inlet for the material to be filtered at the lower end of the side wall of the reverser;

N filters each having a filter core mounted therein, the N-1 filters being communicated with the inlet for the material to be filtered via the material outlets of the reverser and the limiting holes of the rotor, and the remaining one filter being communicated with the slag discharge port via the material outlet of the reverser and the sealed channel.

In the filter device for continuously filtering, once the rotor rotates one time at a predetermined time interval, the filter connected to the reverser sequentially switches to a position with an increased diameter of an adjacent limiting hole and is communicated with the corresponding limiting hole. During the filtering, there is always one filter arranged in a way of communicating with the slag discharge port to perform back-wash operation, and the remaining N-1 filters maintains the same flow of material due to provision of the limiting hole.

In the filter device for continuously filtering, one opening of the rotor is communicated with the slag discharge port provided at the bottom of the reverser via a slag discharge pipe 4 disposed in the interior of the reverser, and the slag discharge pipe is integrally disposed with the rotor.

In the filter device for continuously filtering, the diameter of one opening of the rotor communicated with the slag discharge port of the reverser is identical with an diameter of the material outlets of the reverser.

In the filter device for continuously filtering, at an upper end of a central shaft of the reverser is connected a deceleration clutch 9 which is connected to an implement mechanism, the deceleration clutch is disposed in a way of converting a 90-degree reciprocating movement of the implement mechanism in a manner that the rotor rotating about the central shaft rotates by a position of one limiting hole each time.

In the filter device for continuously filtering, the filter core is made of a back-washable recycled material, for example, a metal power sintered filter core or metal mesh.

In the filter device for continuously filtering according to the present invention, 10 metal powder sintered filter cores are used in each filter, there are totally 10 filters, the reverser is provided as a cylinder with circular upper and lower surfaces, 10 openings are provided on the side wall of the rotor of the reverser, wherein nine openings are limiting holes with sequentially-increased diameters and the remaining one opening has an diameter identical with the diameter of the material outlets of the reverser, nine filters are respectively communicated with the inlet for the material to be filtered via the corresponding limiting holes in turn, and the remaining one filter is communicated with the slag discharge port via the slag discharge pipe. After an inlet flow regulating valve at the inlet for the material to be filtered is opened, a flow rate of the material is controlled from a lower speed to a higher speed; due to a pressure differential the material flows through the reverser towards nine filters communicated with the material outlets until a surface of the filter core forms a solid particle layer and then the filtering is performed with a normal flow. The filtering time is designed to be 200 minutes, the filter switches one time every 20 minutes, namely, the implement mechanism rotates by 90 degrees, the deceleration clutch controls the rotor of the reverser to rotate by 36 degrees, the filter sequentially switches to a position with an increased diameter of an adjacent limiting hole and is communicated with the corresponding limiting hole. At this time, the filter which performs filtering online the longest will be backwashed, the slag is directly discharged through the slag discharge port, and the filtering procedure ends up when each filter undergoes the backwashing one time. During the filtering, there is always one filter communicated with the slag discharge port, continuity of the filtering is ensured, meanwhile the reverser is arranged in a way that a plurality of filters only need to communicated with the inlet for the material to be filtered, the material enters the reverser and then directed into the plurality of filters, thereby reducing the number of valves used at the inlet for the material to be filtered, and cutting the production costs.

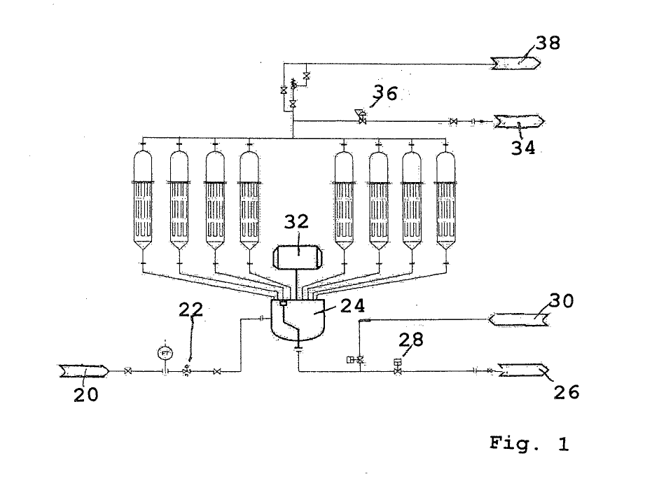

FIG. 1 shows a schematic view of a work flow of a filter device for continuously filtering according to the present invention. A feed inlet flow 20 with a fluid comprising the material for filtering is controlled by the inlet flow regulating valve 22. The material is introduced into the reverser 24. The filter device comprises eight filters. Each filter is connected to the reverser 24. Seven filters are communicating with the inlet for the material to be filtered, and one filter is communicating with the slag discharge port at the bottom of the reverser 24 via a slag discharge pipe. The slag discharge pipe is indicated in FIG. 1 with a bold line inside the reverser 24. The slag discharge port of the reverser 24 is connected to the slag discharge outlet 26. The flow to the slag discharge outlet 26 can be controlled via the back-wash-off valve 28. If the filter is backwashed, the back-wash-off valve 28 is closed, and a fluid is introduced via the replacement fluid inlet 30. The fluid will be entering the reverser 24 through the slag discharge port and the fluid will be flow through the slag discharge pipe to the filter which will be backwashed by the fluid. The used fluid which backwashed the filter will be discharged over the slag discharge outlet 26 by opening the back-wash-off valve 28. Further, FIG. 1 shows that the reverser 24 is connected to an implement mechanism 32 at the top of the reverser 24. The implement mechanism 32 switches the filter which will be backwashed by controlling the connection of the slag discharge pipe with a filter. The filtered material will be released through the filtration fluid out port 34. The pressure of the flow of the fluid comprising the filtered material will be controlled by the outlet flow regulating valve 36. Furthermore, the filtration fluid can be released through the release 38 if the outlet flow regulating valve 36 is closed.

The filter and the filter device can be used to filter all kind of liquids and working solutions of the complete range of liquid-solid filtration applications. One application area is catalyst recovery in chemical processes. Here especially methanol to olefin process, Caprolactam and Hydrogen Peroxide production and TDI/TDA process (upstream products in PET production). The filter device can be used also for product clarification in beverage industry or continuous particle separation from waste water or other liquids (e.g. highly viscose slurry oil).

Although embodiments of the present invention have already been disclosed as above, they are not limited to applications as listed in the description and embodiments, and they can completely be adapted for various fields in which the present invention is applicable. Those skilled in the art can readily implement additional amendments, so the present invention is not limited to specific details and legends shown and depicted here without departing from general concepts defined by claims and equivalent scope of protection.

1. A filter device for continuously filtering, wherein said filter device comprises:
a reverser being a cylindrical container, an inlet for a material to be filtered is formed at a lower end of the side wall of the reverser, N material outlets are formed at an upper end of the side wall of the reverser; a rotor is arranged inside the reverser and arranged in a way rotatable around a center shaft, N openings are provided on the side wall of the rotor at positions corresponding to the material outlets of the reverser, the opening of the rotor is connected to the material outlet of the reverser via a seal seat to form a sealed channel, one opening of the rotor is communicated with a slag discharge port formed in a bottom of the reverser, the N-1 openings of the rotor are limiting holes with sequentially-increased diameters, and are communicated with the inlet for the material to be filtered at the lower end of the side wall of the reverser;
N filters each having a filter core mounted therein, the N-1 filters being communicated with the inlet for the material to be filtered via the material outlets of the reverser and the limiting holes of the rotor, and the other filter being communicated with the slag discharge port via the material outlet of the reverser and the sealed channel.

2. The filter device for continuously filtering according to claim 1, wherein once the rotor rotates one time at a predetermined time interval, the filter connected to the reverser sequentially switches to a position with an increased diameter of an adjacent limiting hole and is communicated with the corresponding limiting hole, and in that during the filtering, there is always one filter arranged in a way of communicating with the slag discharge port to perform back-wash operation, and the remaining N-1 filters maintains the same flow of material due to provision of the limiting hole.

3. The filter device for continuously filtering according to claim 2, wherein one opening of the rotor is communicated with the slag discharge port provided at the bottom of the reverser via a slag discharge pipe disposed in the interior of the reverser, and the slag discharge pipe is integrally disposed with the rotor.

4. The filter device for continuously filtering according to claim 3, wherein the diameter of one opening of the rotor communicated with the slag discharge port of the reverser is identical with a diameter of the material outlets of the reverser.

5. The filter device for continuously filtering according to claim 4, wherein at an upper end of a central shaft of the reverser is connected with a deceleration clutch which is connected to an implement mechanism, the deceleration clutch is disposed in a way of converting a 90-degree reciprocating movement of the implement mechanism in a manner that the rotor rotating about the central shaft rotates by a position of one limiting hole each time.

6. The filter device for continuously filtering according to claim 5, wherein the filter core is made of a back-washable recycled material, for example, a metal power sintered filter core or metal mesh.
